(19) United States
(12) Patent Application Publication
(10) Pub. No.: US 2017/0161768 A1
(43) Pub. Date: Jun. 8, 2017

(54) SYSTEMS, METHODS, AND DEVICES FOR IMPLEMENTING A SCAVENGER HUNT REWARD PROGRAM

(71) Applicant: MASTERCARD INTERNATIONAL INCORPORATED, Purchase, NY (US)

(72) Inventors: Andres Guillermo Lopez, Yonkers, NY (US); Maria Fondeur Butler, New York, NY (US); Birce Arslan, Boston, MA (US); Tyler Welsh, Poway, CA (US); Stephen Parento, White Plains, NY (US)

(73) Assignee: MASTERCARD INTERNATIONAL INCORPORATED, Purchase, NY (US)

(21) Appl. No.: 14/962,026

(22) Filed: Dec. 8, 2015

(51) Int. Cl. G06Q 30/02

(52) U.S. Cl. CPC G06Q 30/0226

(57) ABSTRACT

Systems, methods, and devices for implementing a scavenger hunt reward program are described. Merchant point-of-sale level transaction data is obtained and stored. Other trackable transaction data, such as consumer location at the time of a transaction for example, is also obtained and stored. The received transaction and other trackable data are used to identify qualifying transactions with respect to one or more sets of instructions presented to the consumer. Upon the consumer completing some or all of the sets of instructions, at least one reward program sponsor is informed of such completion, and a reward/benefit is disbursed to the consumer.

### FIELD OF TECHNOLOGY

The present disclosure relates generally to electronically implemented reward programs.

### BACKGROUND

Various consumer reward programs are known to those skilled in the art. Exemplary reward programs incentivize consumer purchasing by rewarding a consumer when the consumer's spend amount meets or exceeds a threshold value. Sometimes these reward programs require the consumer spend the threshold amount in a certain amount of time. For example, a consumer may receive a $10 gift certificate when they spend $50 using their payment card/number (in CNP transactions, which are defined herein below). Other reward programs pay the consumer a percentage of a transaction price depending on the type of transaction involved. For example, a transaction involving groceries may award the consumer 3% of the transaction price and a transaction involving fuel may award the consumer 1% of the transaction price.

While these traditional reward programs incentivize consumer purchasing, they are limited. For example, a consumer involved in one of these typical reward programs only spends when convenient or necessary.

### SUMMARY

Aspects of the present disclosure include specially configured systems, methods, and specially configured devices for implementing a scavenger hunt reward program that incentivizes consumer spending by exploiting human desire to complete tasks and earn rewards. A consumer engages a reward program platform, which enrolls the consumer in the program and tracks the consumer's progress. The reward program platform also provides the consumer with game instruction(s). All of the instructions may be communicated to the consumer at once, or subsequent instructions may be sent to the consumer upon completion of preceding instructions. When the consumer performs a transaction with a merchant point-of-sale (“POS”), various data is gathered. This transaction data is electronically communicated to a reward program originator's device, which selectively stores the individual portions of the data within a purchase and cash activity database or another trackable information database.

The purchase and cash activity database houses data such as, for example, transaction amount, transaction date and time data, transaction item description(s) data, stock keeping unit (“SKU”) data, merchant data, and payment option (e.g., payment card) data. The other trackable information database stores other data trackable at the time of a transaction that is not stored within the purchase and cash activity database. For example, potential other trackable information may include consumer location data.

The reward program platform tracks the consumer's reward program progress by determining the existence of qualifying transactions (i.e., transactions conforming with provided reward program instructions). Upon completion of the program/instructions, the reward program platform informs the program's sponsor(s) of such completion, and the program sponsor(s) disburses a benefit/reward to the consumer.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1 illustrates an overview of a system specially configured for implementing a scavenger hunt reward program according to the present disclosure;

FIGS. 2A through 2D illustrate a system flow diagram illustrating the scavenger hunt reward program implemented on the specially configured system according to the present disclosure;

FIG. 3 illustrates a system specially configured for processing payments and tracking transaction data according to the present disclosure; and

FIGS. 4A through 4C illustrate a process flow diagram detailing a method for implementing the scavenger hunt reward program on the specially configured system according to the present disclosure.

### DETAILED DESCRIPTION

Generally, the term “portable consumer device” (“PCD”) means a portable device capable of and specially configured to engage in consumer transactions. A non-limiting list of PCDs includes a card or payment card, personal digital assistant, computer, tablet, and smartphone.

The terms “card” and “payment card” generally mean a card that can be presented by a consumer to make a payment or that can be used to make a payment in a remote transaction, such as an e-commerce transaction, telephone transaction, or mail order, for example. For example, the cards described herein may be a credit card, debit card, charge card, stored-value card, prepaid card, gift card, and/or any other device that may hold payment account information, such as mobile phones, smartphones, personal digital assistants (PDAs), key fobs, and/or computers.

The term “card-not-present (“CNP”) transaction” generally means a transaction performed without physically presenting the card to a merchant. CNP transactions include e-commerce transactions, which are performed between remote parties over the Internet, mail order transactions, and telephone order transactions, for example.

The detailed description of aspects of the present disclosure set forth herein makes reference to the accompanying drawings and figures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

The present disclosure generally provides specially configured systems, methods, and devices for implementing a scavenger hunt reward program. A consumer accesses/logs into a platform (e.g., graphic user interface (“GUI”)) and registers for the reward program by providing consumer identifying information and payment card identifying information (e.g., payment card number). If the platform is a GUI, the platform may be in communication with an underlying processing component specially configured to perform the functions described herein. The platform is configured to communicate received information via an appropriately configured network, to a system associated with a reward program originator. The program originator may, in some examples, be the issuer of the consumer's payment card. The reward program originator system confirms enrollment of the payment card, and provides an indication of enrollment. In response the platform provides the consumer with at least one set of data for processing or instructions, such as game instructions. All of the instructions may be communicated to the consumer at once, or subsequent instructions or data may be communicated to the consumer in a sequence of files or communications upon completion of or processing preceding instructions.

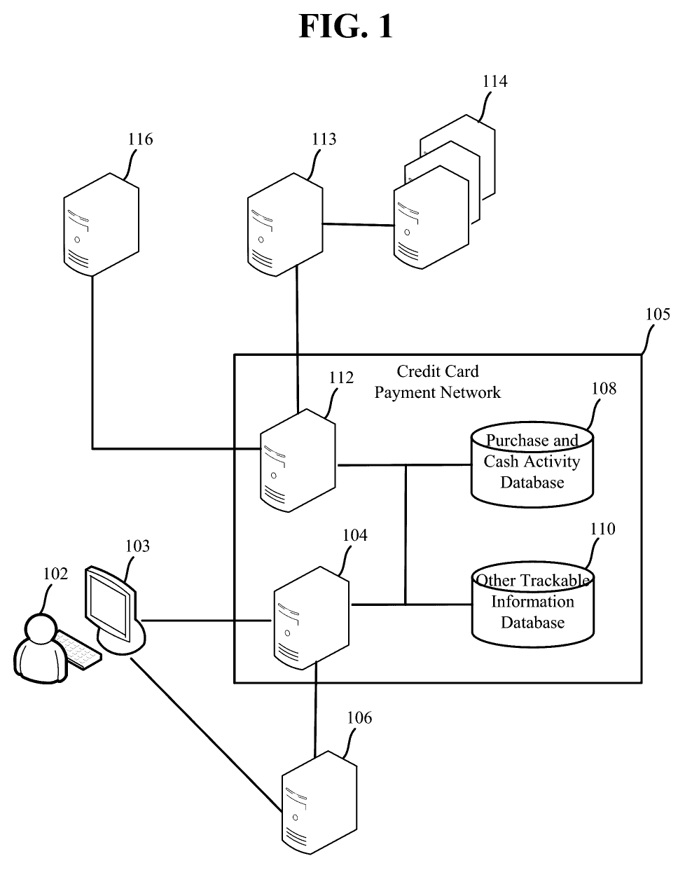

Referring to FIG. 1, in an illustrative embodiment where the reward program originator is the issuer of the consumer's payment card, when a consumer 102 performs a transaction, various data is gathered e.g., at a consumer PCD 103, and communicated to a reward program originator processor, module or platform 104 (the terms “processor,” “module” or “platform” may be used interchangeably herein to describe the specially configured computation device functioning as described), for example within a payment network 105, such as a credit card payment network. The reward program originator processor 104 selectively stores the received data, from e.g. the consumer PCD 103, within a purchase and cash activity database 108 or other trackable information database 110 within the payment network 105. The reward program processor 104 is specially configured to communicate with the purchase activity database 108 to track the consumer's reward program progress by identifying “qualifying transactions” (defined in detail herein below). Upon processing of the first file or set of program or game instructions, i.e. completion of all the game instructions, the reward program processor 104 informs a program's sponsor system 106 of such completion, and the program sponsor system 106 initiates disbursement of the program's benefits/reward to the consumer 102. Such benefits/rewards may be distributed electronically or in physical form. Program sponsors may associate or work with, for example, credit card payment network providers to facilitate reward programs to users of an associated payment card.

In an illustrative embodiment, a reward program may be implemented as a scavenger hunt reward program. In such an embodiment the consumer 102 uses the specially configured computing device 103, such as PCD to execute code for engagement in and access to the reward program processor 104 to enroll in the scavenger hunt reward program. The computing device 103 may be the consumer's PCD, a desktop, laptop, tablet, personal digital assistant, smart phone, or similar device. The reward program processor 104 is a special purpose device configured to perform the functions described herein. Specifically, the reward program processor or platform 104 may provide a GUI through which the consumer 102 provides data to enroll in the scavenger hunt reward program. To enroll, the consumer 102 presents the reward program processor 104 (e.g., inputs data into the reward program processor's corresponding GUI) with personal identifying information (e.g., name, address, etc.) and payment card information such as card number, card security code, and card issuer, for example. The reward program processor 104 validates the consumer 102 data representing the payment card by interfacing with the payment card issuer's system(s) 112 within the specially configured and secure credit card payment network 105. Validation may occur on the consumer device 103 or via the secure credit card payment network 105 on the issuers system 112. Upon validation, the consumer 102 and the payment card is enrolled in the scavenger hunt reward program to receive access to files/data mode available through the reward program platform.

The consumer 102 may also provide the reward program processor 104 (through the GUI) with other identifying information useable to obtain other data pertaining to a transaction. For example, the consumer 102 may provide the reward program processor 104 with a PCD identifier, such as a cellphone number, and authorization number or code for the reward program processor 104 to access the PCD to identify the consumer's location via GPS (global positioning system) at the time of a transaction. In another example, the consumer 102 may provide the reward program processor 104 with an email address. This allows the reward program processor 104 to track, for example, when a digital application (“app”) is purchased using an account associated with the provided email address. One skilled in the art should appreciate that location data is not the only other trackable data obtainable regarding a transaction and, as such, the system may be configured to track other obtainable data not herein described.

The reward program processor 104 is in communication with the purchase and cash activity database 108 and/or other trackable information database 110, through which the reward program processor 104 tracks the consumer's progress or status within the reward program (as described in detail herein below). The purchase and cash activity database 108 includes data pertaining to a transaction such as, for example, transaction amount, date and time of transaction, transaction item description(s), stock keeping unit (“SKU”) data, merchant data, and payment option data (e.g., payment card number, security code, and issuer). The other trackable information database 110 includes data trackable at the time of a transaction that is not stored within the purchase and cash activity database 108. An exemplary and non-limiting list of potential other trackable transaction data includes consumer location, date, time of purchase, related purchases, for example.

The reward program originator processor 104 within the payment network 105 is in communication with the databases 108, 110 and at least one merchant point-of-sale (“POS”) device 114 outside of the payment network 105. The reward program originator processor 104 is a special purpose device specially configured within the payment network 105, as described to perform the functions described herein, and as mentioned above is in communication with the payment card issuer system(s) within the payment network 105. The payment network 105 is in communication with merchant point of sale (“POS”) devices 114, via acquiring financial institution system(s) 113 such as computing devices operated by banks that process point of sale information relating to purchase/sales transactions. The POS device(s) 114 performs a card present or CNP transaction with the consumer 102, obtains transaction trackable data as described herein, and communicates the obtained transaction data to the acquiring (e.g. financial institution or bank) system(s) 113 The acquiring financial institution system(s) 113 in turn transmits the transaction trackable data to the payment card issuer's system(s) 112 within the specially configured and secure payment network 105. The transaction data is then transmitted to an issuing party (e.g. bank) system 116 for authorization of the credit transaction. The issuing party (e.g. bank) system 116 may then authorize the credit transaction and notify the payment card issuer's system(s) 112 which thereafter transmits all or part of the transaction data to the reward program originator processor 104. The payment network 113 may include databases (not illustrated) that store vast amounts of transaction data, including the received transaction data. The reward program originator processor 104 analyzes the received transaction data and selectively stores portions of the data in the databases 108, 110 according to the specific types of data stored within each database. For example, the reward program originator processor 104 stores transaction amount data, date and time data, item description(s) data, stock keeping unit (“SKU”) data, merchant data, and payment card data (e.g., card number) within the purchase and cash activity database 108.

Although the reward program originator processor, module or platform 104 is shown and described as being in communication with the payment card issuer system(s) within the payment network 105, it should be appreciated that those systems may be implemented on the same computational device or a number of computer devices within the network. Similarly, although certain systems are described as being “within” and others “outside” the payment network 113, it should be appreciated that systems may be within or outside the payment network in a manner other than as described herein. For example, issuing systems 116 or acquiring systems 113 may be “within” the payment network in alternative configurations. Further, although transaction data is described as being stored within the payment network, it should be appreciated that the system may obtain transaction data for enrolled users from databases at or within the payment network or directly or indirectly from the issuing systems 116 or acquiring systems 113.

Upon receiving data indicating the card number used in the transaction, the payment card issuer's system(s) 112 may communicate with the reward program processor 104 to determine whether the transacted payment card number is associated with an authorization to determine the consumer's location at the time of the transaction. If authorization was given, the reward program originator processor 104 determines the consumer's location at the time of the transaction, and stores the determined location within the other trackable information database 110. For example, determining the consumer's location may involve the reward program originator processor 104 accessing a PCD (e.g., affiliated with a phone number previously designated by the consumer 102) and directing/requesting the PCD to use a global positioning system (“GPS”) or other like positioning system to determine the consumer's location at the time of the transaction. One skilled in the art should appreciate that computations and communications of electronic devices occur rapidly/near instantaneously. As such, communication with the reward program processor or platform 104 and access of the PCD thereby may occur substantially instantaneously with or slightly after the transaction occurs. In this example, the GPS can determine a present location of the consumer, as that can reasonably be analogous to the location of the consumer at the time of the transaction. In an alternate example, the PCD/GPS may store consumer locations. In this example, the PCD/GPS may be accessed at a desirable time after the transaction, and the consumer's location at the time of the transaction may be determined using the stored consumer location data. Alternatively, for transactions where cards were physically presented to a merchant by a consumer, the location of the POS terminal (obtained from the transaction data) can be used as an approximation of the consumer's location at the time of the transaction.

The reward program platform 104 tracks the consumer's reward program process using the data stored within the purchase and cash activity database 108 and the other trackable information database 110. To track progress, the reward program platform 104 identifies “qualifying transactions” and applies them to the consumer's reward program progress.

For example, an illustrative scavenger hunt game program may include the following instructions: (1) spend a total of $100 at Merchant A; and (2) spend a total of $100 at Merchant B. The reward program platform 104 may provide (i.e., transmit them to the consumer 102 via the GUI or other electronic communication such as email, text etc.) the consumer 102 with the entirety of the game instructions at once in a selected game file. The reward program platform 104 determines whether the consumer's enrolled payment card is affiliated with “qualifying transactions” contained within the databases 108, 110. In this example, a qualifying transaction is one involving either Merchant A or Merchant B since all instructions were presented to the consumer 102 at once. If a transaction qualifies, the amount spent in that transaction is applied to a diminishing spend amount affiliated with the transacted Merchant. In other words, the amount needed to satisfy instructions relating to a merchant decreases with every transaction that occurs with that merchant. The reward program platform 104 tracks transaction information and may be polled to access status (and other information).

In another example, a sample scavenger hunt game program may include the following instructions: (1) spend a total of $100 at Merchant A; and (2) spend a total of $100 at Merchant B. The reward program platform 104 may provide (i.e., transmit them to the consumer 102 via the GUI or other electronic communication such as email, etc.) the consumer 102 with the instructions piecemeal (i.e., provide the Merchant A instructions upon enrollment and provide the Merchant B instructions upon completion of the Merchant A instructions). In this example, a qualifying transaction involves Merchant A if the Merchant A instructions were provided and not completed when the transaction occurred or a qualifying transaction involves Merchant B if the Merchant B instructions were provided and not completed when the transaction occurred. Thus, if the Merchant A instructions are provided to the consumer 102 and have yet to be completed (i.e., Merchant B instructions have not been provided to consumer yet), a transaction involving Merchant B is not a qualifying transaction, and will not decrease the amount needed to satisfy the Merchant B instructions.

However, upon the Merchant A instructions being completed and the Merchant B instructions being provided to the consumer 102, the reward program platform 104 may identify a previously unqualifying transaction involving Merchant B as qualifying if it was made within a certain time frame (i.e., grace period) prior to the Merchant B instructions being provided. By way of example, suppose the consumer 102 transacts with Merchant B while the Merchant A instructions are uncompleted. Once the consumer 102 completes the Merchant A instructions, the reward program platform 104 provides the Merchant B instructions to the consumer 102 and determines whether the consumer 102 transacted with Merchant B within the “grace period.” Exemplary and non-limiting grace periods include within one day prior to the subsequent (i.e., Merchant B) instructions being provided, within one week prior to the subsequent (i.e., Merchant B) instructions being provided, and within one month prior to the subsequent (i.e., Merchant B) instructions being provided. Thus, even though the Merchant B transaction occurred prior to the Merchant B instructions being provided, the Merchant B transaction is a qualifying transaction if it occurred within the grace period. A grace period may be selected as a function of user status, instructions or rewards achieved, or other incentive or objectives. While the exemplary reward program has been described as having two (2) sets of instructions (i.e., Merchant A and Merchant B), one skilled in the art should appreciate the reward program having other than two (2) sets of instructions. In any example, the reward program platform 104 may be polled or otherwise accessed to access status or other information (e.g. instructions remaining or completed).

The reward program platform 104 is also in communication with a program sponsor device 106. The reward program platform 104 informs the program sponsor device 106 when the consumer 102 completes the scavenger hunt reward program. The program sponsor 106 then disperses a benefit/reward to the consumer 102.

As illustrated, the reward program platform 104 is in communication with a single program sponsor device 106. Thus, the scavenger hunt reward program may be sponsored by a single entity. However, one skilled in the art should appreciate that the scavenger hunt reward program may be sponsored by more than one entity. When more than one entity sponsors the scavenger hunt reward program, the reward program platform 104 may be in communication with a device of each program sponsor. Moreover, as described, the reward/benefit of the program is disbursed when the program is completed by the consumer 102. However, one skilled in the art should appreciate that a reward/benefit may be disbursed upon completion of one or more sets of instructions of the program. As such, the reward program platform 104 may inform the program sponsor device 106 upon completion of each set of instructions.

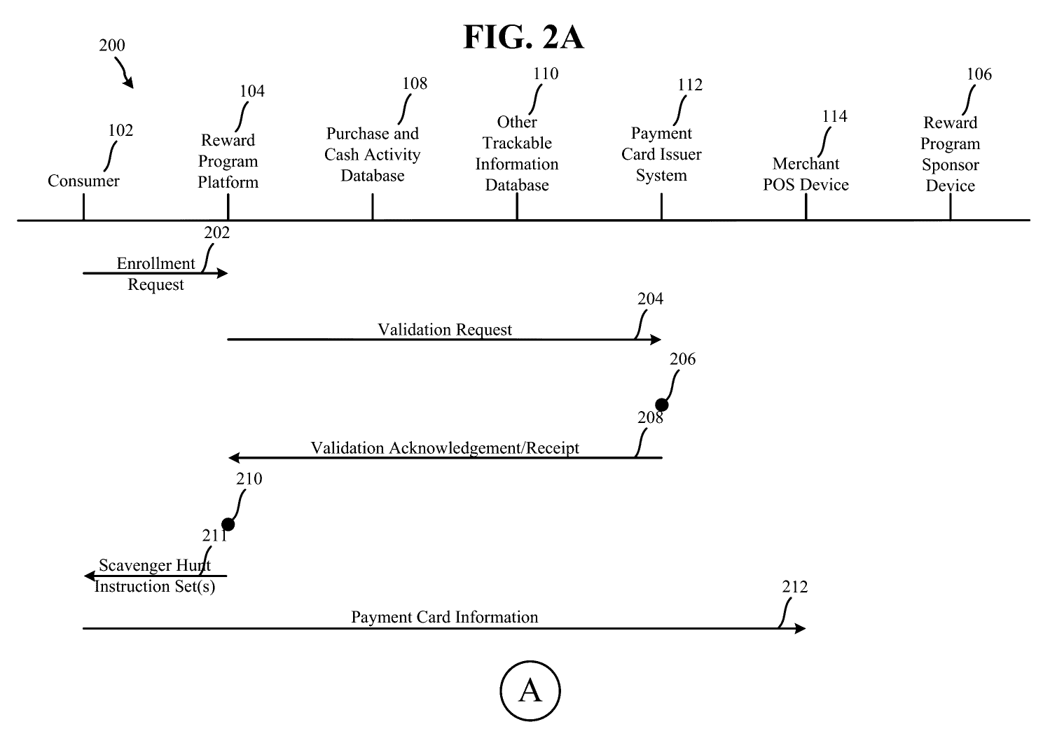

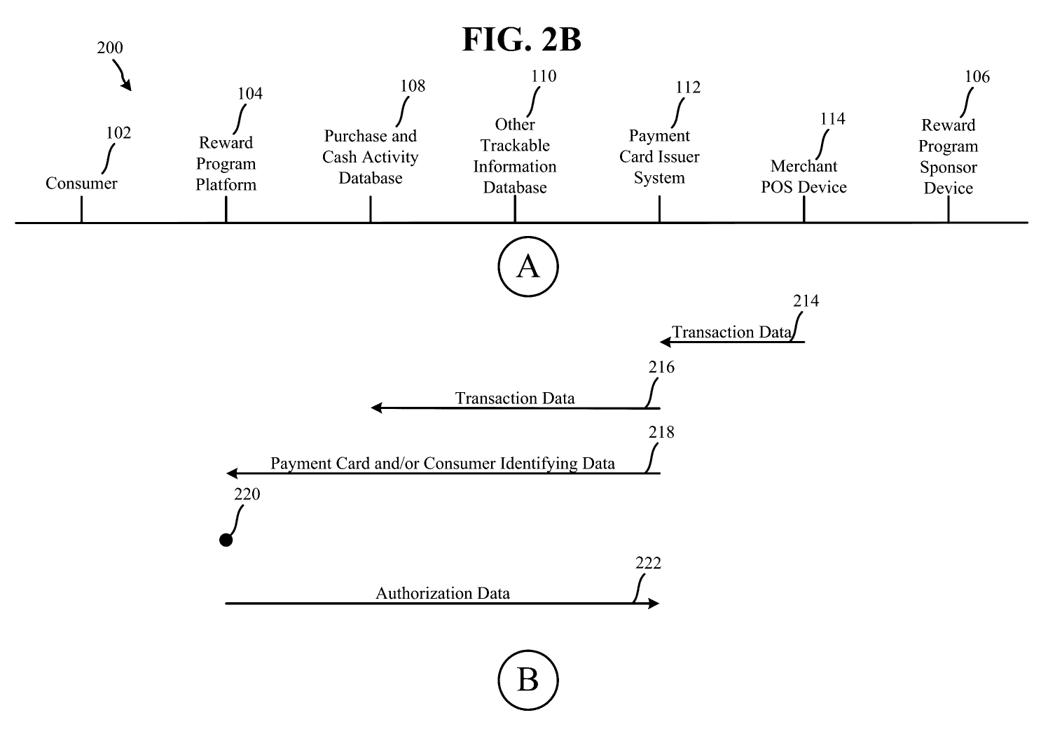

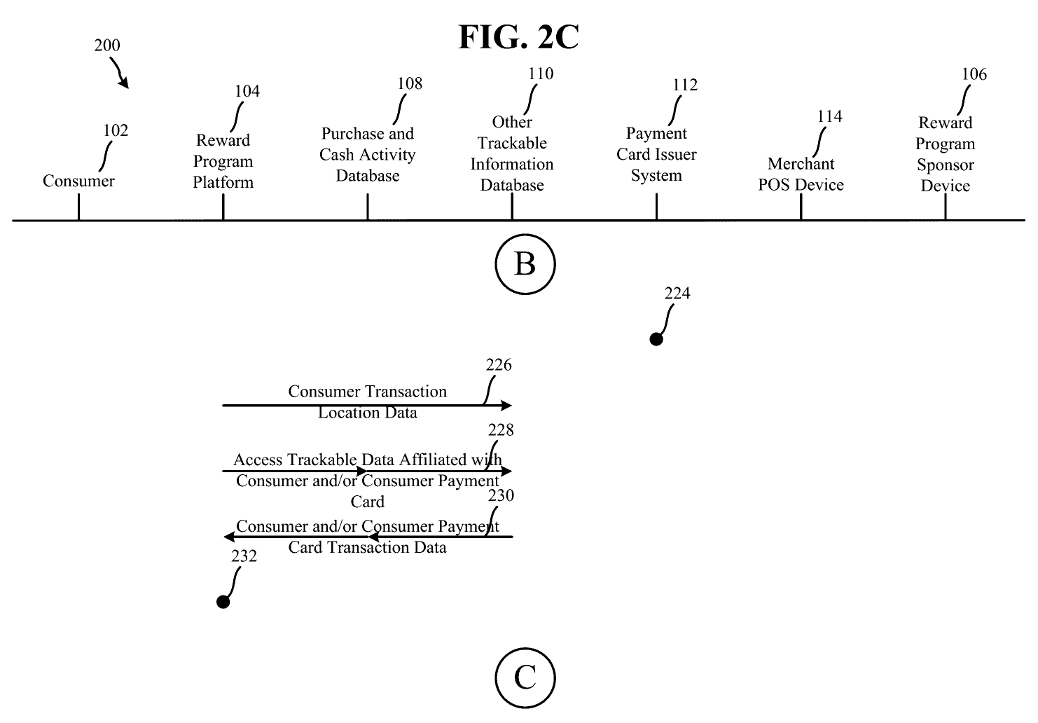

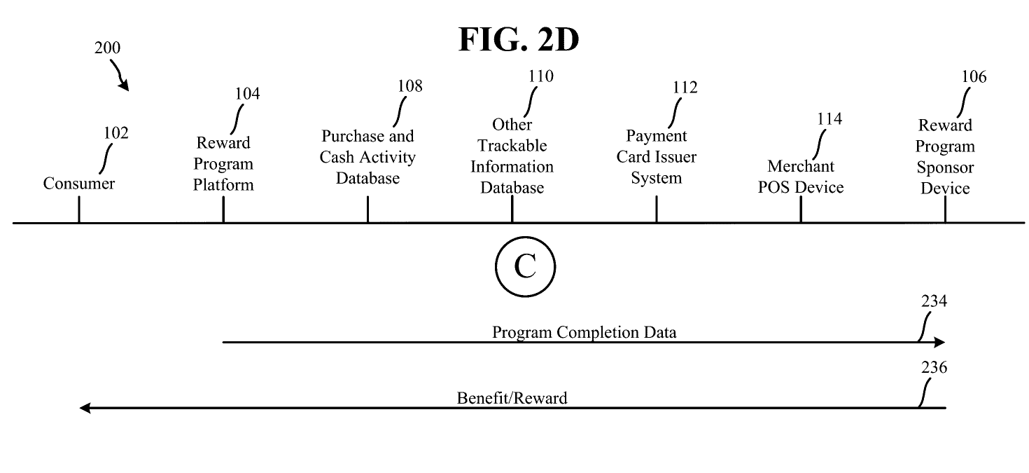

Attention is now given to FIGS. 2A through 2D, which illustrate a system flow 200 according to the scavenger hunt reward program. As illustrated in FIG. 2A, the consumer 102 transmits an enrollment request, using a general or special purpose computing device, to the reward program platform 104 (illustrated as 202). This may optionally include the consumer 102 inputting information into a GUI provided by the reward program platform 104. The general or special purpose computing device used by the consumer 102 to transmit the enrollment request may be a desktop, laptop, tablet, personal digital assistant, smart phone, or similar device configured to provide the functionality as described herein. The enrollment request includes consumer 102 identifying information (e.g., name, address, etc.) and payment card information such as card number, card security code, and card issuer, for example. The enrollment request may also include other identifying information useable to obtain other data of a transaction. For example, the enrollment request may include a PCD identifier, such as a cellphone number, and an authorization for the PCD to be accessed to determine the consumer's location at the time of a transaction. In another example, the enrollment request may include an email address, which allows for the tracking of, for example, when a digital application (“app”) is purchased using an account associated with the provided email address. One skilled in the art should appreciate that location data is not the only other trackable data obtainable during a transaction and, as such, should appreciate that the enrollment request may include authorization to track other obtainable data not herein described.

The reward program platform 104 sends a validation request to the payment card issuer system 112 (illustrated as 204). The validation request includes at least some of the consumer identifying and payment card information of the enrollment request. The payment card issuer system 112 validates the consumer with the payment card (illustrated as 206). The payment card issuer system 112 may be operated by the issuer of the consumer's payment card and, as such, may internally validate the consumer with the payment card. Alternatively, if the payment card issuer system 112 is not operated by the consumer's payment card issuer, the payment card issuer system 112 may contact a device of the payment card issuer or of the consumer's or issuer bank for validation. Upon validation, the payment card issuer system 112 transmits a validation acknowledgement/receipt to the reward program platform 104 (illustrated as 208). Upon receipt of the validation acknowledgement/receipt, the reward program platform 104 enrolls the consumer 102 and their payment card/number in the scavenger hunt reward program (illustrated as 210). This may include storing the consumer 102 identifying information and the payment card information within a program enrollee database (not illustrated). Additionally, the reward program platform 104 transmits at least one set of instructions of a scavenger hunt game to the consumer 102 (illustrated as 211).

The consumer 102 engages in a transaction with a merchant by providing the merchant POS device 114 with a payment card or payment card information (in the case of a CNP transaction) (illustrated as 212). The transaction may be a card present transaction (i.e., the consumer's payment card is physically or proximally interacted with the merchant POS device 114) or CNP transaction as defined herein. As illustrated in FIG. 2B, the merchant POS device 114 transmits transaction data to the payment card issuer system 112 either directly or indirectly via the issuer of the transacted payment card (e.g., payment network 105) (illustrated as 214) or through an acquiring institution system 113. The transaction data may include transaction amount data, date and time of transaction data, item description(s) data, stock keeping unit (“SKU”) data, merchant identification data, and payment card data (e.g., card number and issuer). The payment card issuer system 112 transmits the received transaction data to the purchase and cash activity database 108 for storage (illustrated as 216). Alternatively, the payment card issuer system 112 may transmit the received transaction data to the purchase and cash activity database 108 for storage by first transferring it to the reward program platform 104 which then transmits the received transaction data to the purchase and cash activity database 108 for storage.

The payment card issuer system 112 also transmits payment card data and/or consumer identifying data correlated with the payment card during the transaction to the reward program platform 104 to determine whether the transacted payment card and/or consumer is affiliated with an authorization to access the consumer's PCD to obtain additional trackable data (illustrated as 218). It should be appreciated that this transmission of data may be from the reward program platform 104 to the payment card issuer system 112. Additional trackable data may include consumer location at the time of transaction. The reward program platform 104 determines whether such authorization exists (illustrated as 220) and transmits authorization data to the payment card issuer system 112 (illustrated as 222). As illustrated in FIG. 2C, the payment card issuer system 112 analyzes the authorization data to determine whether authorization was given (illustrated as 224). If authorization was given, the reward program originator platform 104 accesses the consumer's PCD (e.g., affiliated with the phone number designated within the enrollment request) (not shown) and directs the PCD to determine the consumer's location at the time of the transaction (not illustrated). The PCD may determine the location using a global positioning system (“GPS”). Moreover, the PCD may determine a current location of the consumer or a previous location of the consumer depending on when the PCD is instructed to determine the consumer's location at the time of the transaction. For example, if the PCD is instructed contemporaneously with the transaction, the PCD may determine the consumer's present location and identify it as the location of the consumer at the time of the transaction. Alternatively, if the PCD is instructed at a time after the transaction transpired, the PCD may determine the location of the consumer at the time of the transaction using historical stored location data. Alternatively, for transactions where cards were physically presented to a merchant by a consumer, if the PCD is unable to determine the consumer's location, the location of the POS terminal (obtained from the transaction data) can be used as an approximation of the consumer's location at the time of the transaction. Upon receiving the consumer's location at the time of the transaction from the PCD (not illustrated), the reward program originator platform 104 transmits data indicating the consumer's location at the time of the transaction to the other trackable information database 110 for storage (illustrated as 226).

The reward program platform 104 communicates with the purchase and cash activity database 108 and the other trackable information database 110 to track the consumer's reward program progress (illustrated as 228). The reward program platform 104 thereby receives data affiliated with the consumer 102 and/or the consumer's payment card from one or both of the databases 108, 110 (illustrated as 230). Upon acquisition of the data, the reward program platform 104 determines whether the consumer 102 has completed some or all sets of instructions of the reward program (illustrated as 232). In so doing, the reward program platform 104 identifies “qualifying transactions” and applies transaction amounts of the qualifying transactions to the consumer's reward program progress.

Referring now to FIG. 2D, upon completion, the reward program platform 104 transmits program completion data to the reward program sponsor device 106 when the reward program platform 104 determines the consumer 102 has completed the instructions provided (illustrated as 234). The reward program sponsor device 106 thereafter disperses a program benefit/reward to the consumer 102 (illustrated as 236).

As illustrated in FIG. 2D, the reward program platform 104 transmits program completion data (illustrated as 234) to reward program sponsor device(s) 106. When more than one entity sponsors the program, the reward program platform 104 may transmit program completion data to one or more relevant program sponsors at a time. For example, the reward program platform 104 may transmit the program completion data to all of the program sponsors upon completion of the entire program, or may transmit instruction set completion data to each sponsor individually when a set of instructions pertaining to the sponsor is completed.

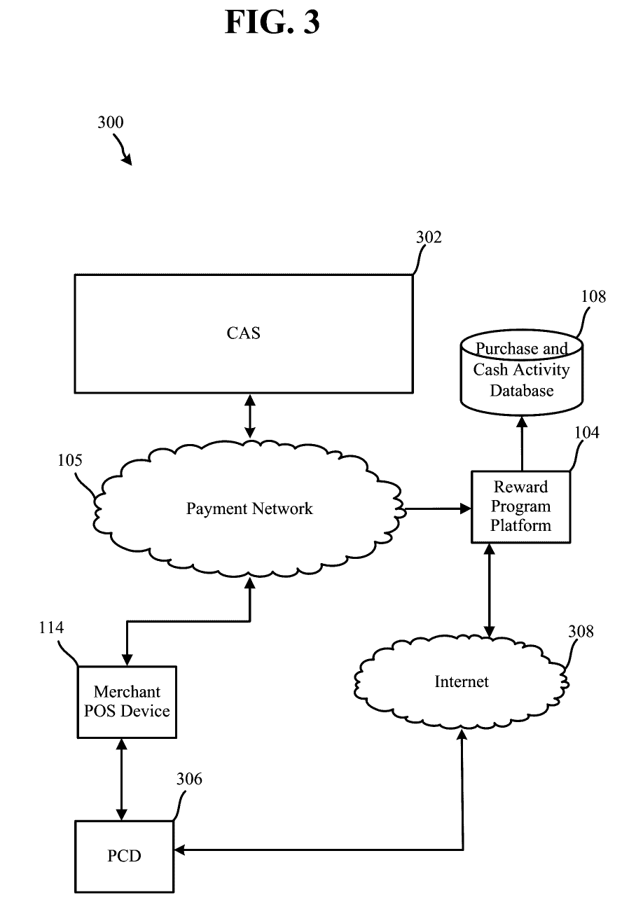

Referring to FIG. 3, a further embodiment of a system 300 for processing payments and tracking transaction data having a reward program platform 104 that is not a part of the payment network 105 is described. The system 300 includes a Card Authorization System (“CAS”) 302, the payment network 113, a consumer PCD 306, the merchant POS device 114, the reward program platform 104, the purchase and cash activity database 108, and the Internet 308.

The payment network 105 is configured to communicate with various payment acquirers, such as the merchant POS device 114. The payment network 105 also communicates with payment card issuers and cardholders.

The CAS 302 is configured to perform all or part of an authorization process in relation to a payment transaction associated with a transaction account. The CAS 302 may comprise combinations of hardware and software, such as servers, databases, firewalls, computers, etc., in order to authorize transactions. As illustrated, the CAS 302 and the reward program originator platform 104 are two distinct special purpose devices. However, one skilled in the art should appreciate that the CAS 302 and the reward program originator platform 104 may be a single special purpose device or system of special purpose devices that perform the functions and operations of the CAS 302, the reward program originator platform 104 and the payment card issuer device 112 individually described in detail herein.

The PCD 306 (or card number in a CNP transaction) is presented to the merchant POS device 114 to pay for a transaction. Transaction data, such as card number, transaction amount, and the like, is transmitted securely to the CAS 302 via the payment network 105. The CAS 302 authorizes the transaction using the transaction data and an account affiliated with the PCD 306 (or card number in the CNP transaction context). Upon authorization and completion of the transaction, the merchant POS device 114 securely transmits transaction data to the payment network 105, which then transmits all or part of the received transaction data to the reward program originator platform 104. Alternatively, the payment network 105 may securely transmit the transaction data to the CAS 302, which in turn may transmit the transaction data to the purchase and cash activity database 108 either directly or indirectly via the reward program originator platform 104. A different level of security may be provided to the communications with the reward program originator platform than the CAS 302 depending on data communicated. The transaction data received by the reward program originator platform 104 may include, for example, transaction amount, date and time of transaction, transaction item description(s), stock keeping unit (“SKU”) data, merchant data, and payment option data (e.g., payment card number, security code, and issuer). Again, if payment option data or other data is not requiring high levels of security communicated to the reward program originator device, that device and associated components may be managed at other levels of security. The reward program originator platform or device 104 thereby stores the received transaction data within the purchase and cash activity database 108 (alternatively as described hereinbefore the transaction data may be stored indirectly through the payment card issuer system 112).

The PCD 306 may transmit trackable transaction data to the reward program originator platform 104 via the Internet 308. For example, this trackable transaction data may include the location of the consumer at the time of the transaction.

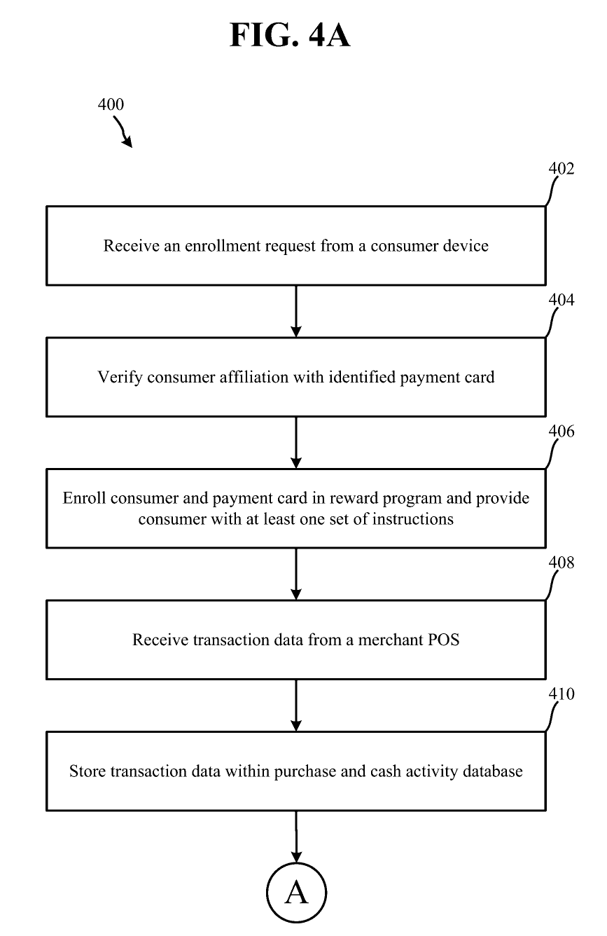

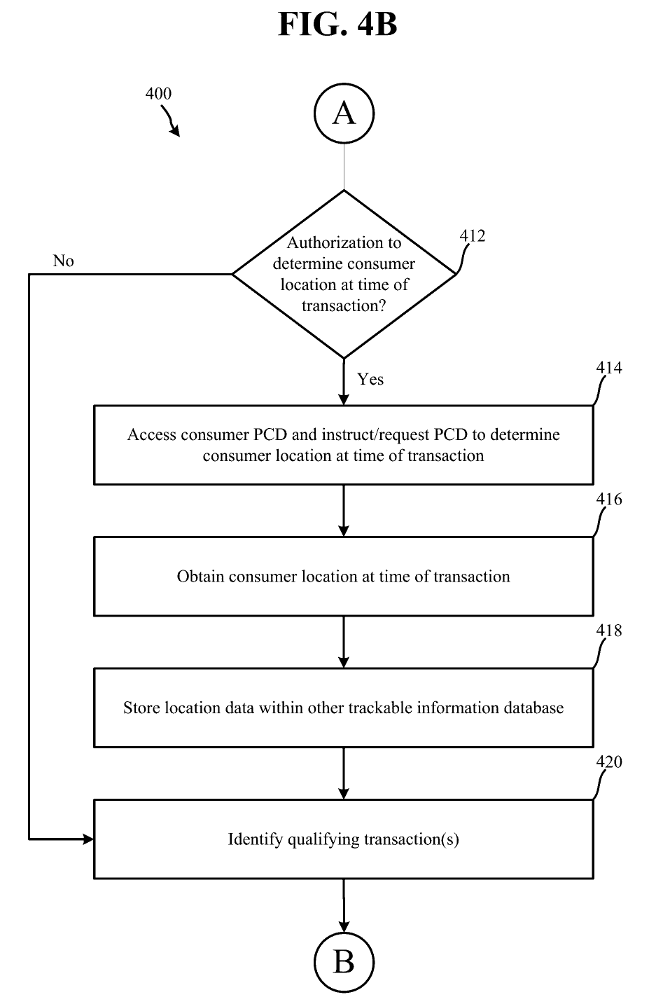

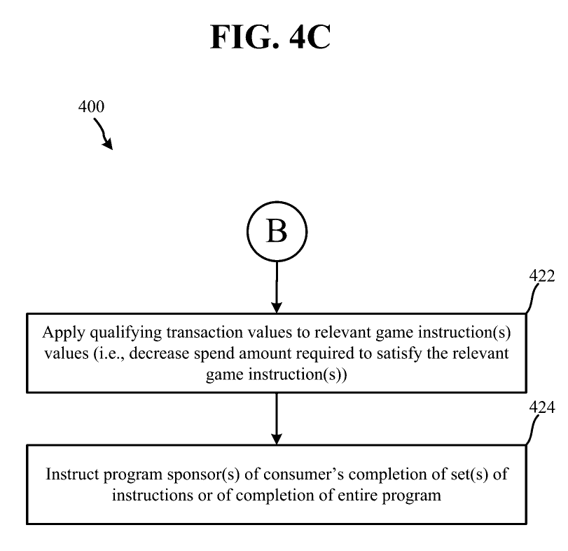

Attention is now given to FIGS. 4A through 4C, which illustrate a method 400 for implementing the scavenger hunt reward program in the specially configured system as described. At block 402 an enrollment request is received from a consumer device. The consumer device may be a general or special purpose computing device, such as a desktop, laptop, tablet, personal digital assistance, smart phone, or similar device. As discussed, the enrollment request includes consumer identifying information (e.g., name, address, etc.) and payment card information such as card number, card security code, and card issuer, for example. The enrollment request may also include a PCD identifier, such as a cellphone number, and an authorization for the PCD to be accessed to determine the consumer's location at the time of a transaction. In another example, the enrollment request may include an email address, which allows for the tracking of, for example, when a digital application (“app”) is purchased using an account associated with the provided email address.

At block 404 a consumer affiliated with the identified payment card is verified. Some or all of the consumer and payment card information of the enrollment request may be transmitted to the identified payment card's issuer, and the issuer may instruct that the consumer and payment card information corresponds with a payment account of the payment card. At block 406 the consumer and the identified payment card are enrolled in the scavenger hunt reward program and the consumer (via the consumer device) is provided with a file or program code containing at least one set of game instructions. Enrollment of the consumer and the payment card may include storing consumer and payment card data within an enrollee database (not illustrated). At block 408 transaction data is received from a merchant POS. The transaction data may include transaction amount data, date and time of transaction data, item description(s) data, stock keeping unit (“SKU”) data, merchant identification data, and payment card data (e.g., card number and issuer). At block 410 some or all of the received transaction data is stored within a purchase and cash activity database. The data stored within the purchase and cash activity database may be stored according to payment card number or consumer name, for example.

At block 412 it is determined whether authorization was given by the consumer to access the consumer's PCD to determine a location of the consumer at the time of the transaction. This may include accessing a reward program enrollee database. If authorization was given, the consumer PCD (e.g., affiliated with a phone number previously designated by the consumer) is accessed and directed/requested to determine the consumer's location at the time of the transaction (illustrated as block 414). The consumer's location at the time of the transaction is thereafter received from the PCD (illustrated as block 416) and the received location data is stored within another trackable information database (illustrated as 418).

After the location data is stored (illustrated as block 418) or if authorization was not given to determine the consumer's location at the time of the transaction, qualifying transactions are identified using the data stored within the purchase and cash activity database, and optionally the other trackable information database (illustrated as block 420).

At block 422 identified qualifying transaction values are applied to relevant game instruction values as described above. At block 424 the program's sponsor(s) is instructed of the consumer's completion of either individual sets of program instructions or of the consumer's completion of the entire program.

Systems, methods, and computer program products are provided according to the disclosure. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Embodiments of the present disclosure are described herein with reference to the accompanying drawings. However, the present disclosure should not be construed as limited to the embodiments set forth herein. Rather, these embodiments are provided as illustrative to convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used herein, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component could be termed a second element or component without departing from the teaching of the present disclosure.

It will be appreciated that one or more aspects of a system can include a computer program comprising computer program code means adapted to perform one or more steps described when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Specially configured computers programmed to implement the methods, steps and logic discussed herein can be interconnected, for example, by one or more of network, a virtual private network (VPN), the Internet, a local area and/or wide area network (LAN and/or WAN), via an EDI layer, and so on providing appropriate security as described.

The present system or any part(s) or function(s) thereof may be implemented using hardware, software, or a combination thereof and may be implemented in one or more specially configured computer systems or other processing systems. The manipulations performed by embodiments were often referred to in terms, such as assessing, determining, matching or selecting, which are commonly associated with mental operations performed by a human operator. However, no such capability of a human operator is necessary in any of the operations described herein. Rather, the operations are machine operations performed by the specially configured machine or system operating according to the disclosure. After reading this description, it will become apparent to a person skilled in the relevant art(s) how to implement various embodiments by specially configuring other computer systems and/or architectures.

Databases or data warehouses discussed herein may include relational, hierarchical, graphical, or object-oriented structure and/or various other particularly structured database configurations implementing data storage for the specially configured machine/system. Moreover, the databases may be organized as data tables or lookup tables. Each record may be a single file, a series of files, a linked series of data fields, or other data structure. Association of certain data may be accomplished through desired data association techniques such as those known or practiced in the art.

As will be appreciated by one of ordinary skill in the art, the specially configured system according to the disclosure may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having a computer readable program code means embodied in the storage medium. Any, of various suitable computer-readable storage medium may be utilized, including hard disks, CD-ROM, optical storage devices, magnetic storage devices, and/or the like.

The system and method are described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program logic or instructions.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A device for implementing a scavenger hunt reward program, comprising:
a memory;
at least one processor operatively coupled to the memory; and
a persistent storage device operatively coupled to the memory and storing in a non-transitory manner instructions that when loaded into the memory cause the at least one processor to be operative to:
receive an enrollment request from a consumer device, the enrollment request including consumer identifying information and payment card identifying information, the payment card identifying information including a payment card number;
enroll the payment card number in the scavenger hunt reward program;
transmit instructions to the consumer device, the instructions detailing purchase activity;
receive transaction data from a payment network;
determine whether the received transaction data is qualifying transaction data with respect to the transmitted instructions;
update a reward program progress of the payment card number when the transaction data is qualifying transaction data; and
transmit program completion data to a reward program sponsor device when the purchase activity instructions are completed.

2. The device of claim 1, wherein the at least one processor is further operative to determine whether the enrollment request included authorization to determine a location of a consumer at the time of a transaction.

3. The device of claim 2, wherein the at least one processor is further operative to communicate with a portable consumer device of the consumer and obtain transaction location data from the portable consumer device.

4. The device of claim 1, wherein the received transaction data is qualifying transaction data when the transacted merchant POS device belongs to a merchant evidenced in the instructions provided to the consumer device.

5. The device of claim 1, wherein the at least one processor is further operative to transmit subsequent instructions to the consumer device when the instructions are completed.

6. A method for implementing a scavenger hunt reward program, comprising the steps of:
receiving an enrollment request from a consumer device, the enrollment request including consumer identifying information and payment card identifying information;
enrolling a payment card identified within the payment card identifying information in the scavenger hunt reward program;
transmitting purchase activity instructions to the consumer device;
receiving transaction data from a payment network, the payment network receiving the transaction data from a merchant point of sale (POS) device;
determining whether the received transaction data is qualifying transaction data; and
transmitting program completion data to a reward program sponsor device when the instructions are completed.

7. The method of claim 6, further comprising the step of:
updating a reward program progress of the consumer when the received transaction data is qualifying transaction data.

8. The method of claim 6, wherein the payment card identifying information includes a payment card number.

9. The method of claim 6, further comprising the step of:
determining when the enrollment request included an authorization to access the consumer device to determine a location of the consumer device when the payment network received the transaction data from the merchant POS device.

10. The method of claim 9, further comprising the steps of:
accessing the consumer device; and
directing the consumer device to determine the location of the consumer device when the payment network received the transaction data from the merchant POS device

11. The method of claim 10, wherein the consumer device is directed to determine a current location of the consumer device.

12. The method of claim 10, further comprising the step of:
in response to the consumer device being unable to determine the location of the consumer device, determining a location of the consumer device using a location of the merchant POS device.

13. A system for implementing a scavenger hunt reward program, comprising:
a reward program originator device including a memory, at least one processor operatively coupled to the memory, and a persistent storage device operatively coupled to the memory and storing in a non-transitory manner instructions that when loaded into the memory cause the at least one processor to be operative to:
enroll a payment card number in the scavenger hunt reward program;
transmit purchase activity instructions to a consumer device;
receive transaction data from a payment network;
determine whether the received transaction data is qualifying transaction data;
update a reward program progress of the payment card number when the transaction data is qualifying transaction data; and
transmit program completion data to a reward program sponsor device when the purchase activity instructions are completed.

14. The system of claim 13, wherein the at least one processor is further operative to:
receive an enrollment request from the consumer device, the enrollment request including an authorization to determine a transaction location of the consumer device.

15. The system of claim 14, wherein the transaction location is determined using a location of a merchant point of sale (POS) device.

16. The system of claim 14, wherein the transaction location is determined using a current location of the consumer device.

17. The system of claim 14, wherein the at least one processor is further operative to:
direct the consumer device to determine the transaction location using a global positioning system (GPS).

18. The system of claim 13, wherein the at least one processor is further operative to:
transmitting subsequent purchase activity instructions to the consumer device when the program completion data is transmitted to the reward program sponsor device.

19. The system of claim 13, wherein the at least one processor receives the transaction data from the payment network after the payment network authorizes a transaction relating to the transaction data.

20. The system of claim 13, wherein the instructions require spending of an allotment of money at a specific merchant establishment.
